(19) United States
(12) Patent Application Publication
(10) Pub. No.: US 2001/0019375 A1
(43) Pub. Date: Sep. 6, 2001

(54) Liquid crystal display device and fabricating method thereof

(76) Inventors: Oh Nam Kwon, Uiwang-shi (KR); Kwang Jo Hwang, Anyang-shi (KR)

Correspondence Address: LONG ALDRIDGE & NORMAN LLP, 701 Pennsylvania Avenue, N.W., Washington, DC, 20004, US

(21) Appl. No.: 09/788,420

(22) Filed: Feb. 21, 2001

(30) Foreign Application Priority Data
Feb. 21, 2000 (KR) 200-08313

(51) Int. Cl. G02F 1/136

(52) U.S. Cl. 349/43

(57) ABSTRACT

A liquid crystal display device includes a substrate, a gate electrode on the substrate, an insulating layer on the gate electrode, a semiconductor layer on the insulating layer, an ohmic contact layer on the semiconductor layer, source and drain electrodes on the ohmic contact layer, a protective layer on the source and drain electrodes, the protective layer having a hole exposing a portion of one of the source and drain electrodes, a conductive electrode on the protective layer and electrically contacting the one of the source and drain electrodes, and a contact layer between the one of the source and drain electrodes and the conductive electrode.

This application claims the benefit of Korean Patent Application No. P00-08313, filed on Feb. 21, 2000, the entirety of which is hereby incorporated by reference as if fully set forth herein.

### BACKGROUND OF THE INVENTION

1. Field of the Invention

The present invention relates to a liquid crystal display, and more particularly, to a liquid crystal display device and a fabricating method thereof that are capable of reducing a contact resistance between a single metal layer with a good conductivity and a transparent electrode.

2. Discussion of the Related Art

Generally, liquid crystal displays (LCDs) control light transmissivity of liquid crystal cells in response to a video signal to thereby display a picture corresponding to the video signal on a liquid crystal display panel. An active matrix type in such LCDs provided with a switching device for each liquid crystal cell is suitable for displaying a moving picture. In the active matrix LCD, a thin film transistor (TFT) is mainly used as the switching device.

The LCD includes thin film transistors provided at each intersection between gate lines and data lines, a lower substrate including pixel electrodes connected to TFTs, an upper substrate provided with color filters, and liquid crystal injected between the upper and lower substrates. The TFT consists of a gate electrode, a gate insulating film, an active layer, and source and drain electrodes. The TFT passes a data signal from the data line to the pixel electrode in response to a gate signal from the gate line to thereby drive the liquid crystal cell.

FIG. 1A to FIG. 1D show a method of fabricating a conventional LCD, referring to a TFT portion and a gate pad portion.

As shown in FIG. 1A, a metal material is deposited onto a transparent substrate 10 and then patterned to form a gate line, a gate electrode 12 and a gate pad 14. As shown in FIG. 1B, a gate insulating film 16 is formed at the upper portion of the transparent substrate 10 provided with the gate line, the gate electrode 12 and the gate pad 14. Thereafter, an amorphous silicon layer and an amorphous silicon layer doped with an impurity are sequentially formed and then patterned, to thereby form an active layer 18 and an ohmic contact layer 20. As shown in FIG. 1C, a metal material is deposited onto the upper portion of the gate insulating film 16 provided with the active layer 18 and the ohmic contact layer 20 and then patterned, to form source and drain electrodes 22 and 24, a data line and a data pad. Subsequently, the ohmic contact layer 20 exposed between the source electrode 22 and the drain electrode 24 is etched to expose the active layer 18. As shown in FIG. 1D, an insulating material is entirely deposited onto the substrate having such a structure to form a protective film 26 and then is patterned, to thereby define a contact hole for exposing the drain electrode 24 and a contact hole for exposing the gate pad 14 and the data pad. As shown in FIG. 1E, a transparent electrode material is entirely deposited thereon and then patterned, to thereby form a pixel electrode 28 contacting the drain electrode 24 and a protective electrode 30 contacting the gate pad 14 and the data pad.

In such an LCD, an Al-series metal material with a good conductivity is generally used as a material of the metal electrode. In particular, because Al has problems of hillock and diffusion, an Al alloy such as AlNd has been mainly used. However, such an Al-series material causes a problem in that it has a large contact resistance against the pixel electrode and the transparent electrode used as a protective electrode. Accordingly, the metal electrode layer takes a double metal layer structure such as Mo/AlNd, Mo/Al or Cr/AlNd using a refractory metal such as Mo or Cr which has a good contact resistance to the transparent electrode. However, since a two-step etching process is needed when the metal electrode layer takes the double metal layer structure, an additional process step is required and the manufacturing cost increases.

### SUMMARY OF THE INVENTION

Accordingly, the present invention is directed to a liquid crystal display device and a fabricating method thereof that substantially obviates one or more of the problems due to limitations and disadvantages of the related art.

An advantage of the present invention is to provide a method of reducing a contact resistance between a single metal layer and a transparent electrode.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a liquid crystal display device includes a contact layer formed at an exposed portion of a metal electrode contacting a transparent electrode and made from a metal material having a small contact resistance against the transparent electrode.

In another aspect of the present invention, a method of fabricating a liquid crystal display device includes forming a metal electrode line and a thin film transistor on a transparent substrate; forming a protective film to cover a signal wire and a thin film transistor and then patterning it, thereby forming a contact hole; forming a contact layer at the upper portion of a metal electrode exposed via the contact hole using one of an electric plating technique and a non-electrolytic plating technique; and forming a transparent electrode contacting the contact layer on a protective film.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1A to FIG. 1E are section views representing a conventional method of fabricating a liquid crystal display;

FIG. 2 is a section view showing a structure of a liquid crystal display device according to an embodiment of the present invention; and

FIG. 3A to FIG. 3E are section views representing a method of fabricating a liquid crystal display device according to an embodiment of the present invention.

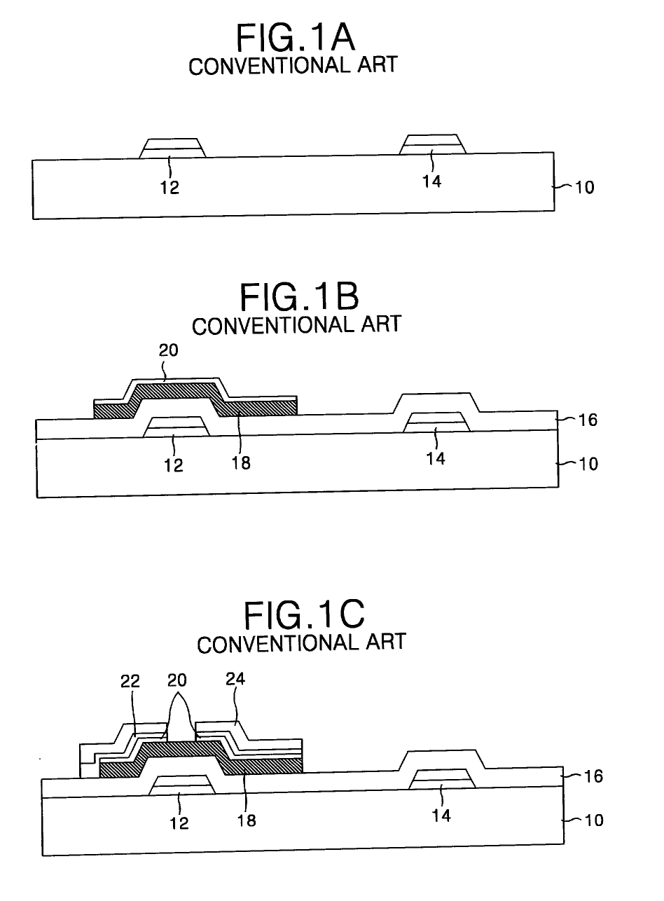

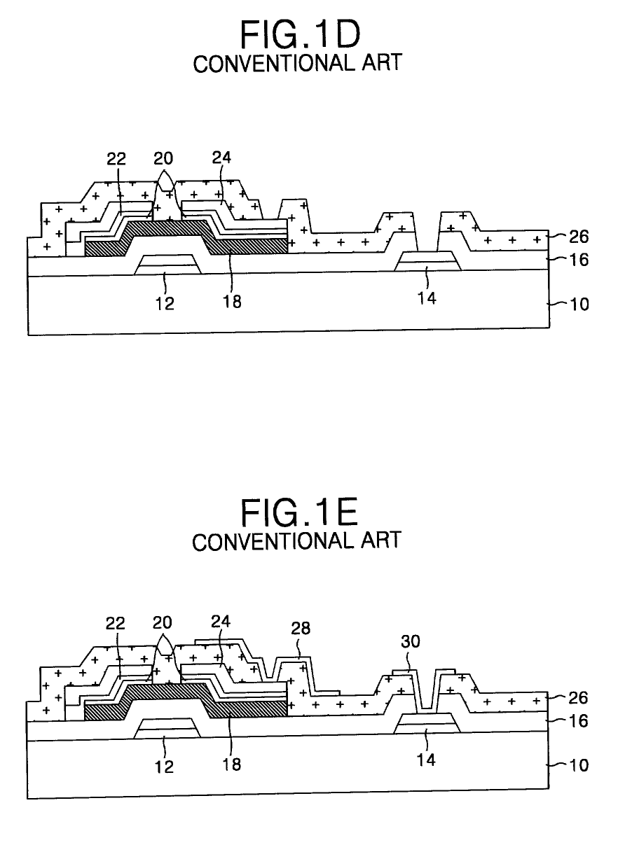

### DETAILED DESCRIPTION OF THE PREFERRED EMBODIMENTS

Reference will now be made in detail to the preferred embodiments of the present invention, examples of which are illustrated in the accompanying drawings.

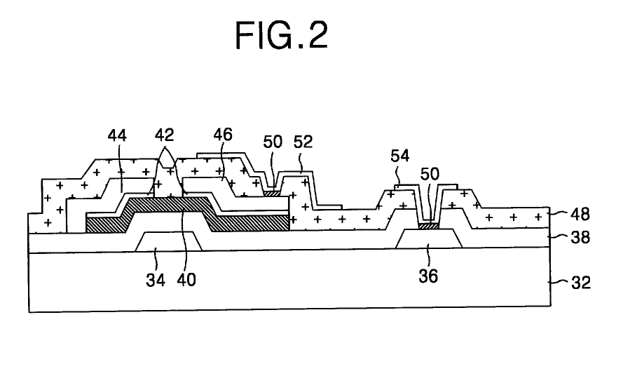

FIG. 2 is a section view showing a structure of a liquid crystal display device according to an embodiment of the present invention. FIG. 2 particularly shows only a thin film transistor portion and a gate pad portion.

Referring to FIG. 2, the liquid crystal display device of the present invention includes a gate electrode 34 and gate pad 36 on a substrate 32. An insulating layer 38 is over the substrate. An active layer 40 and an ohmic contact layer 42 are formed on the insulating layer 38. Source and drain electrodes 44 and 46 are formed on the ohmic contact layer 42. A protective film 48 is formed on the resultant substrate and a pixel electrode 52 and protective electrode 54 are formed on the protective film 48. The pixel electrode 52 contacts the drain electrode 46 through a contact hole 47 in the protective film 48 and the protective electrode 54 contacts the gate pad 36 through another contact hole 49 in the protective film 48. A contact layer 50 is formed between the pixel electrode 52 and the drain electrode 46 as well as between the protective electrode 54 and the gate pad 36. Here, the gate electrode 34 and gate pad 36 are preferable shown as a single layer.

The contact layer 50 includes a metal, such as Mo, Ni, Cr, Cu, Ag or Pb, having a small contact resistance with the transparent electrodes 52 and 54. The contact layer 50 reduces the contact resistance even when only an Al-series single metal layer with a good conductivity is used as wires and electrodes.

Although the data pad is not shown, the contact layer 50 is positioned between the protective electrode 54 and the data pad.

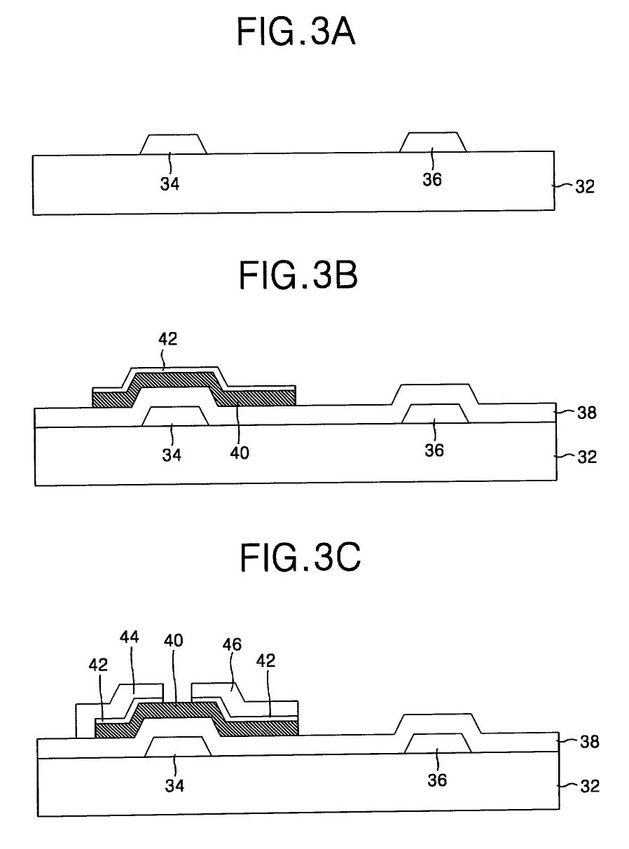

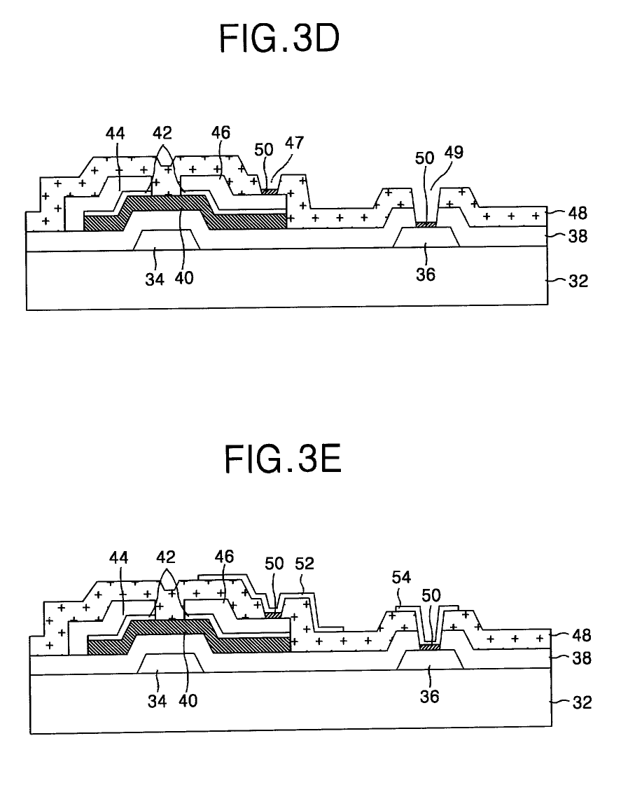

FIGS. 3A-3D show a method of fabricating a liquid crystal display device according to an embodiment of the present invention. FIGS. 3A-3D particularly show a TFT portion and a gate pad portion.

As shown in FIG. 3A, an Al-series metal material with a good conductivity is deposited onto a transparent substrate 32 and then patterned to thereby form a gate line, a gate electrode 34, and a gate pad 36. As shown in FIG. 3B, a gate insulating film 38 is formed at the upper portion of the transparent substrate 32 provided with the gate line, the gate electrode 34 and the gate pad 36. Thereafter, an amorphous silicon layer and an amorphous silicon layer doped with an impurity are sequentially formed and then patterned to thereby form an active layer 40 and an ohmic contact layer 42. As shown in FIG. 3C, an Al-series metal material with a good conductivity is deposited onto the upper portion of the gate insulating film 38 provided with the active layer 40 and the ohmic contact layer 42 and then patterned to thereby source and drain electrodes 44 and 46, a data line and a data pad. Subsequently, the ohmic contact layer 42 exposed between the source electrode 44 and the drain electrode 46 is etched to expose the active layer 40. As shown in FIG. 3D, an insulating material is deposited onto the entire substrate, having such a structure to form a protective film 48 and then is patterned to thereby define a first contact hole 47 for exposing the drain electrode 46 and a second contact hole 49 for exposing the gate pad 36 and the data pad. A contact layer 50 is formed at the surfaces of the drain electrode 46 exposed via the first contact hole 47 and the pad 36 exposed via the second contact hole 49 preferably using an electric plating technique or a non-electrolytic plating technique. The contact layer 50 includes a metal, such as Mo, Ni, Cr, Cu, Ag or Pb, having a small contact resistance with the transparent electrode material. After forming the contact layer 50, as shown in FIG. 3E, a transparent electrode material is entirely deposited thereon and then patterned to thereby form a pixel electrode 52 contacting the drain electrode 46, and a protective electrode 54 contacting the gate pad 36 and the data pad.

As described above, according to the present invention, the contact layer capable of reducing a contact resistance with the transparent electrode material is preferably provided only at the metal electrode portion exposed via the contact hole so that only an Al-series single metal layer with a good conductivity can be used as wires and electrodes. Accordingly, an additional process step is not needed and the manufacturing cost can be reduced in comparison with the conventional device having a double metal layer to reduce a contact resistance.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display device comprising:
a substrate;
a first conductive layer on the substrate;
a first insulating layer on the first conductive layer;
a second conductive layer on the first insulating layer;
a third conductive layer on the second conductive layer;
a second insulating layer on the third conductive layer, the second insulating layer having a hole exposing a portion of the third conductive layer;
a fourth conductive layer on the second insulating layer and electrically contacting the third conductive layer; and
a fifth conductive layer between the third conductive layer and the fourth conductive layer.

2. The liquid crystal display device according to claim 1, wherein the first conductive layer includes a metal.

3. The liquid crystal display device according to claim 2, wherein the metal includes Al.

4. The liquid crystal display device according to claim 1, wherein the second conductive layer includes a semiconductor.

5. The liquid crystal display device according to claim 4, wherein the third conductive layer has first and second parts spaced from each other and the semiconductor is etched at between the first and second parts of the third conductive layer.

6. The liquid crystal display device according to claim 1, wherein the third conductive layer includes a metal.

7. The liquid crystal display device according to claim 1, wherein the fourth conductive layer includes a transparent electrode.

8. The liquid crystal display device according to claim 1, wherein the fifth conductive layer includes a metal.

9. The liquid crystal display device according to claim 8, wherein the metal is selected from the group consisting of Mo, Ni, Cr, Cu, Ag and Pb.

10. The liquid crystal display device according to claim 1, further comprising a second semiconductor layer between the first insulating layer and the second conductive layer.

11. The liquid crystal display device comprising:
a substrate having first and second regions;
a thin film transistor on the first region of the substrate;
a pad portion on the second region of the substrate, the pad portion including:
a first conductive layer on the substrate;
a first insulating layer on the first conductive layer;
a second insulating layer on the first insulating layer, the second insulating layer having a hole exposing a portion the first conductive layer;
a second conductive layer on the portion of the first conductive layer and contacting the first conductive layer; and
a third conductive layer on the second insulating layer and contacting the second conductive layer through the hole in the second insulating layer.

12. The liquid crystal display device according to claim 1, wherein the first conductive layer includes a metal.

13. The liquid crystal display device according to claim 12, wherein the metal includes Al.

14. The liquid crystal display device according to claim 12, wherein the third conductive layer includes a transparent electrode.

15. The liquid crystal display device according to claim 12, wherein the second conductive layer includes a metal.

16. The liquid crystal display device according to claim 15, wherein the metal is selected from the group consisting of Mo, Ni, Cr, Cu, Ag and Pb.

17. A liquid crystal display device comprising:
a substrate having first and second regions;
a switching device on the first region of the substrate, the switching device including:
a first conductive layer on the substrate;
a first insulating layer on the first conductive layer;
a second conductive layer on the first insulating layer;
a third conductive layer on the second conductive layer;
a second insulating layer on the third conductive layer, the second insulating layer having a first hole exposing a portion of the third conductive layer;
a fourth conductive layer on the second insulating layer and electrically contacting the third conductive layer; and
a fifth conductive layer between the third conductive layer and the fourth conductive layer; and
a pad portion on the second region of the substrate, the pad portion including:
the first conductive layer on the substrate;
the first insulating layer on the first conductive layer;
the second insulating layer on the first insulating layer, the second insulating layer having a second hole exposing a portion the first conductive layer;
the fifth conductive layer on the portion of the first conductive layer and contacting the first conductive layer; and
the fourth conductive layer on the second insulating layer and contacting the fifth conductive layer through the second hole in the second insulating layer.

18. The liquid crystal display device according to claim 17, wherein fifth conductive layer is selected from a group consisting of Mo, Ni, Cr, Cu, Ag and Pb.

19. A liquid crystal display device comprising:
a substrate;
a gate electrode on the substrate;
an insulating layer on the gate electrode;
a semiconductor layer on the insulating layer;
an ohmic contact layer on the semiconductor layer;
source and drain electrodes on the ohmic contact layer;
a protective layer on the source and drain electrodes, the protective layer having a hole exposing a portion of one of the source and drain electrodes;
a conductive electrode on the protective layer and electrically contacting the one of the source and drain electrodes; and
a contact layer between the one of the source and drain electrodes and the conductive electrode.

20. The liquid crystal display device according to claim 19, further comprising a pad portion on the substrate, the pad portion including:
a conductive pad on the substrate;
the insulating layer on the conductive pad;
the protective layer on the insulating layer, the protective layer having a second hole over the pad;
the contact layer contacting the pad through the second hole; and
the conductive electrode contacting the contact layer through the second hole.

21. The liquid crystal display device according to claim 19, wherein the contact layer is selected from a group consisting of Mo, Ni, Cr, Cu, Ag and Pb.

22. A method of fabricating a liquid crystal display device comprising:
forming a switching device on a first region of a substrate, the switching device including:
a first conductive layer on the substrate;
a first insulating layer on the first conductive layer;
a second conductive layer on the first insulating layer;
a third conductive layer on the second conductive layer;
a second insulating layer on the third conductive layer, the second insulating layer having a first hole exposing a portion of the third conductive layer;
a fourth conductive layer on the second insulating layer and electrically contacting the third conductive layer; and
a fifth conductive layer between the third conductive layer and the fourth conductive layer; and
forming a pad portion on a second region of the substrate, the pad portion including:
the first conductive layer on the substrate;
the first insulating layer on the first conductive layer;
the second insulating layer on the first insulating layer, the second insulating layer having a second hole exposing a portion the first conductive layer;
the fifth conductive layer on the portion of the first conductive layer and contacting the first conductive layer; and
the fourth conductive layer on the second insulating layer and contacting the fifth conductive layer through the second hole in the second insulating layer.

23. The method according to claim 22, wherein fifth conductive layer is selected from a group consisting of Mo, Ni, Cr, Cu, Ag and Pb.

24. A method of forming a liquid crystal display device comprising:
forming a gate electrode on a substrate;
forming an insulating layer on the gate electrode;
forming a semiconductor layer on the insulating layer;
forming an ohmic contact layer on the semiconductor layer;
forming source and drain electrodes on the ohmic contact layer;
forming a protective layer on the source and drain electrodes, the protective layer having a hole exposing a portion of one of the source and drain electrodes;
forming a conductive electrode on the protective layer and electrically contacting the one of the source and drain electrodes; and
forming a contact layer between the one of the source and drain electrodes and the conductive electrode.

25. The method according to claim 24, further comprising forming a pad portion on the substrate, the pad portion including:
a conductive pad on the substrate;
the insulating layer on the conductive pad;
the protective layer on the insulating layer, the protective layer having a second hole over the pad;
the contact layer contacting the pad through the second hole; and
the conductive electrode contacting the contact layer through the second hole.

26. The method according to claim 25, wherein the contact layer is selected from a group consisting of Mo, Ni, Cr, Cu, Ag and Pb.
